(19) United States
(12) Patent Application Publication
(10) Pub. No.: US 2004/0255200 A1
(43) Pub. Date: Dec. 16, 2004

(54) Method for automatically projecting a technological module for reproducing and controlling a technological process system

(75) Inventors: Thomas Fischer, Billigheim (DE); Frank Luther, Hassloch (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/796,196

(22) Filed: Mar. 10, 2004

Related U.S. Application Data
(63) Continuation of application No. PCT/DE02/03151, filed on Aug. 28, 2002.

(30) Foreign Application Priority Data
Sep. 10, 2001 (DE) 10144386.2

(51) Int. Cl. H02H 3/05

(52) U.S. Cl. 714/38

(57) ABSTRACT

A method for automatically configuring a technology module, for representing and controlling a technical process system which is connected to a computer user station through at least one interface for transferring data (e.g. process, state, open-loop and closed-loop control data). The user specifies the type of at least one process element of the process system and specifies the start address of a memory module associated with the process element. The technology module is then automatically completed by allocating at least one signaling element, archive data element and/or picture element to the specified process element.

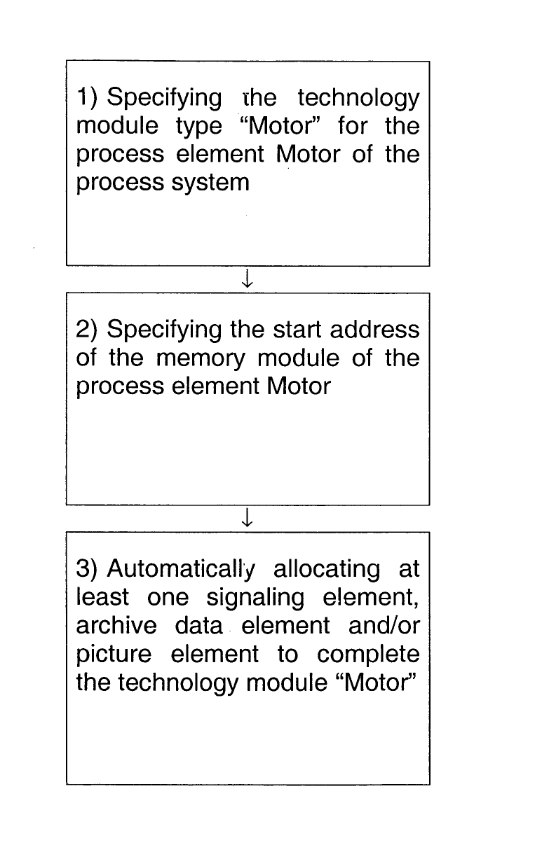

This is a Continuation of International Application PCT/DE02/03151, with an international filing date of Aug. 28, 2002, which was published under PCT Article 21(2) in German, and the disclosure of which is incorporated into this application by reference.

### FIELD OF AND BACKGROUND OF THE INVENTION

The invention relates to a method for automatically configuring a technology module, for representing and controlling a technical process system, which is connected to a computer user station via at least one interface for transferring data (e.g. process, state, open-loop and/or closed-loop control data). Therein, the user specifies the type of at least one process element of the process system and the start address of a memory module associated with this process element.

It is known in the art to display data (e.g. process, state, open-loop and/or closed-loop control data) of a technical process system using technology modules (operator communication blocks) on a user interface of a computer user station for representing and controlling the technical process system. During the configuration, a technology module must be assigned to at least one process element of the process system. (Sub)functions of the technology module, such as signaling, archiving and/or visualization of state and/or process data, are executed via separate manual configuration of individual submodules of the technology module. This configuration can be done in configuration systems that are known per se (e.g. WinCC).

### OBJECTS OF THE INVENTION

One particular object of the invention is to provide a timesaving and efficient method for automatically configuring a technology module for representing and controlling a technical process system on the user interface of a computer user station.

### SUMMARY OF THE INVENTION

This and other objects are attained, according to one formulation of the invention, by a method for automatically configuring a technology module, for representing and controlling a technical process system that is connected to a computer user station via at least one interface for transferring data. The method includes a user specifying the type of at least one process element of the process system and the start address of a memory module associated with the process element; and automatically completing the technology module by allocating at least one of a signaling element, an archive data element and a picture element to the process element. The technology module and the at least one signaling element, archive data element or picture element are stored as a logically connected unit, and the logically connected unit is centrally processed and managed.

In the method according to the invention for automatically configuring a technology module for representing and controlling a technical process system, the user specifies the type of at least one process element of the process system as well as the start address of a memory module associated with this process element, and the corresponding technology module is automatically completed. This is accomplished by allocating at least one signaling element, one archive data element and/or one picture element. As a result, the specified elements no longer need to be configured separately and manually, as was the case before. Instead, the specified technology component is configured automatically, completely and with finality. This prevents configuration errors, and the entire configuration can be completed in a shorter time.

According to an advantageous variant of the inventive method, the signaling element, the archive data element and/or the picture element are stored as a logically connected unit together with the technology module. As a result, the individual elements can be found together with the technology module at a specific memory location, so that no separate memory locations have to be registered.

The technology module is, in particular, also centrally processed and managed, so that it is no longer necessary to search for and separately process separately stored and scattered operator communication (sub)blocks, as in the prior art.

Advantageously, a plurality of types of process elements that the user can select at the start of an automatic configuration of a technology module are stored in a library, e.g. in the computer user station. The user can comfortably search such a library for suitable types of individual process elements of the process system. The types available to the user for selection as individual process elements can be, for example, the types “motor,” “sensor,” “valve” or other technical components of the process system.

According to a further advantageous variant of the method, individual types of process elements, or groups of types of process elements, are each associated with at least one signaling element, archive data element and/or picture element. When individual types of process elements are specified at the start of the configuration of a technology module, this module can be automatically completed. This is accomplished by assigning the technology module a signaling element, an archive data element and/or a picture element according to the allocation, to complete the technology module.

In another advantageous variant of the method, the allocations between the individual types and/or groups of types of process elements and the respective signaling element(s), archive data element(s) and/or picture element(s) can be modified (by the user) to adapt them to the requirements of the corresponding process system and the requirements of the user.

The signaling element according to the invention is used, in particular, to detect object-specific signals of the process element that are directed to the computer user station. For example, if the process element is a motor, the signaling element can acquire, e.g., information on motor overheating, short-circuiting, etc. This information can then be displayed on the user interface of the computer user station via the technology module.

The archive data element according to the invention is used, in particular, to archive state or process data of the process element, e.g., in the computer user station. For example, if the process element is a motor, certain state or process data, e.g., speed, temperature, torque, etc. can be detected in the archive data element over a certain period of time such that it is retrievable, e.g., for display on the user interface of the computer user station.

The picture element according to the invention is used, in particular, to display object-specific signals or state or process variables of the process element on the user interface of the computer user station. With a suitable form of this visualization, the display of the process element and the process system can be modeled on the user interface of the computer user station.

### BRIEF DESCRIPTION OF THE DRAWINGS

Further details of the invention are illustrated in the drawing FIGURE, which shows a flow chart of individual process steps for automatically configuring a technology module according to the invention.

### DETAILED DESCRIPTION OF THE PREFERRED EMBODIMENTS

The FIGURE shows, by way of example, in a technical process system (e.g. a combination of machine tools with individual converter motors) in which the process element is an individual motor, the configuration of a technology module for representing and controlling a motor.

First, as in the prior art configuration methods, the user selects the type “motor” from the available basic types (types) of technology modules for the process element “motor” (process step 1). With this selection of a basic type, the structural configuration of a memory module associated with the process element is also selected.

According to the invention, the type “motor” is distinguished, for instance, from the type “sensor” in that it includes, from the outset, an allocation to a signaling element for detecting motor overheating and to an archive data element for archiving speed data in anticipation that the technology module, when it is completed, would be supplemented by suitable signaling elements and archive data elements.

The user further specifies the start address of the memory module associated with the process element and the type “motor”, e.g. a stored program controller (SPC) (process step 2). In this step, it is specified, for instance, that, in the memory module—whose structural configuration is known—the motor status (ON/OFF) is present as a string with offset 20 bytes and the speed as a floating point with offset 31 bytes. In the memory module, state and/or process data of the motor are stored at specific storage locations (offset information). As a result, when the technology module is completed, the storage locations within the memory module of the particular data of interest are known.

Process step 3 differs from that of the prior art. According to the invention, the technology module is completed by automatically allocating at least one signaling element, archive data element and/or picture element, which is known per se. The corresponding signaling elements, archive data elements and/or picture elements to be selected are stored, in particular, in libraries that are accessible for the automatic configuration of the technology module.

The allocation between the type “motor” selected in process step 1 and the individual kinds of signaling elements, archive data elements and/or picture elements is predefined, such that the technology module can be automatically configured and completed.

In the present case, the type “motor” can, for example, be assigned a signaling element for signaling overheating of the motor and an archive data element for archiving the motor speed. The type “motor” can further be assigned a picture element for displaying speed information that is stored in the memory module at a specified address, e.g. in alphanumerical form on the user interface of the computer user station.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A method for automatically configuring a technology module, for representing and controlling a technical process system that is connected to a computer user station via at least one interface for transferring data, comprising:
a user specifying the type of at least one process element of the process system and the start address of a memory module associated with the process element; and
automatically completing the technology module by allocating at least one of a signaling element, an archive data element and a picture element to the process element,
wherein the technology module and the at least one signaling element, archive data element or picture element are stored as a logically connected unit; and
wherein the logically connected unit is centrally processed and managed.

2. The method as claimed in claim 1, wherein the data comprises at least one of process data, state data, open-loop data, and closed-loop control data.

3. The method as claimed in claim 1, wherein a plurality of types of process elements are stored in a library.

4. The method as claimed in claim 3, wherein the library is provided in the computer user station.

5. The method as claimed in claim 1, wherein the at least one signaling element, archive data element or picture element is assigned respectively to individual types of process elements.

6. The method as claimed in claim 5, wherein the at least one signaling element, archive data element or picture element is assigned to a group of types of process elements.

7. The method as claimed in claim 5, further comprising modifying the allocation of the signaling element, archive data element or picture element to the individual types of process elements.

8. The method as claimed in claim 6, further comprising modifying the allocation of the signaling element, archive data element or picture element to the group of types of process elements.

9. The method as claimed in claim 1, wherein the signaling element is configured to detect object-specific signals of the process element in the computer user station.

10. The method as claimed in claim 1, wherein the archive data element is configured to archive at least one of state data or process data of the process element in the computer user station.

11. The method as claimed in claim 1, wherein the picture element is configured to display at least one of object-specific signals, state variables or process variables of the process element on the user interface of the computer user station.
